(19) United States
(12) Patent Application Publication
(10) Pub. No.: US 2007/0183840 A1
(43) Pub. Date: Aug. 9, 2007

(54) Organizer

(76) Inventors: Stuart I. Graff, Chicago, IL (US); Michael L. Pyle, Sugar Grove, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/171,945

(22) Filed: Jun. 30, 2005

(51) Int. Cl. B42F 13/00

(52) U.S. Cl. 402/79

(57) ABSTRACT

An organizer that includes a first and second panel and a binder panel disposed between the first and second panel and a storage insert including a plurality of sheets that is attached to the binder panel. The inner surfaces of the front and back panel are free for additional storage configurations.

### BACKGROUND

1. Field of the Disclosure

The present disclosure is generally directed to organizers, and more particularly to organizers with cascading sleeves.

2. Description of Related Art

Organizers are known in the art. For example day planner type folders which include pages for holding business cards are common. In such devices, each page is attached to the front or back panel of the folder or to the rings of a three-ring type binder. A user must flip through each page to find the desired card. This process can be both time consuming and frustrating for the user.

Alternatively, some organizers have been provided attempting to include cascading pages which may be pulled out to display portions of multiple pages at the same time. Such systems, while allowing the user to more quickly identify a particular item generally have the pages attached to an interior surface of either the front or back cover of the device. This configuration necessarily prevents at least one interior cover surface from storing additional items, such as, for example, writing instruments, PDA's, cell phones, credit cards and the like.

### BRIEF DESCRIPTION OF THE DRAWINGS

Objects, features, and advantages of the present invention will become apparent upon reading the following description in conjunction with the drawing figures, in which:

FIG. 1A is a perspective view of one example of an organizer constructed in accordance with the teachings of the disclosure and shown in an open condition;

FIG. 1B is an end view of the organizer of FIG. 1 and shown in a closed condition;

FIG. 1C is a perspective view of the organizer of FIG. 1 shown in an open condition and with a storage insert in an extended condition;

FIG. 2 is an end view of the organizer of FIG. 1 shown in an open condition;

FIG. 3 is an end view of the storage insert of the organizer of FIG. 1, the storage insert being shown in an extended condition;

FIG. 4 is an end view of the storage insert of FIG. 3 shown in a retracted condition;

FIG. 5 is an enlarged end view of the storage insert of FIG. 3 and illustrating two sheets of the storage insert in a retracted condition;

FIG. 6 is a perspective view of an alternative embodiment of an organizer constructed in accordance with the teachings of the disclosure.

### DETAILED DESCRIPTION OF THE DISCLOSURE

An organizer is provided which includes a front panel, a back panel and a binder panel disposed therebetween. A storage insert, which includes a plurality of sheets, each having one or more pockets for storing business cards, index cards, letters and the like, is attached to the binder portion thus freeing the front and back panels for additional storage. This additional storage feature enhances the utility of the organizer above that of previous organizer devices which attach storage sheets to the front or back panel. The disclosed organizer is also less complex and therefore less expensive to produce over three-ring type binders.

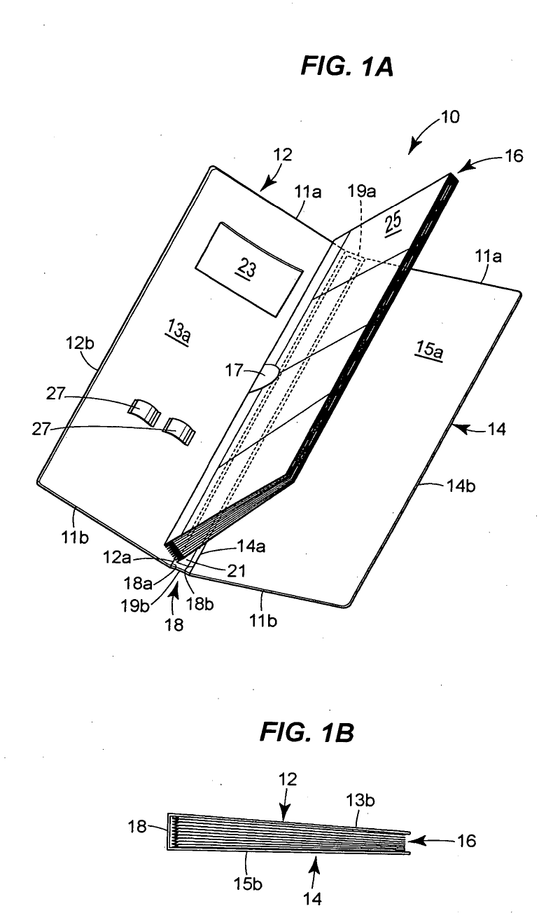

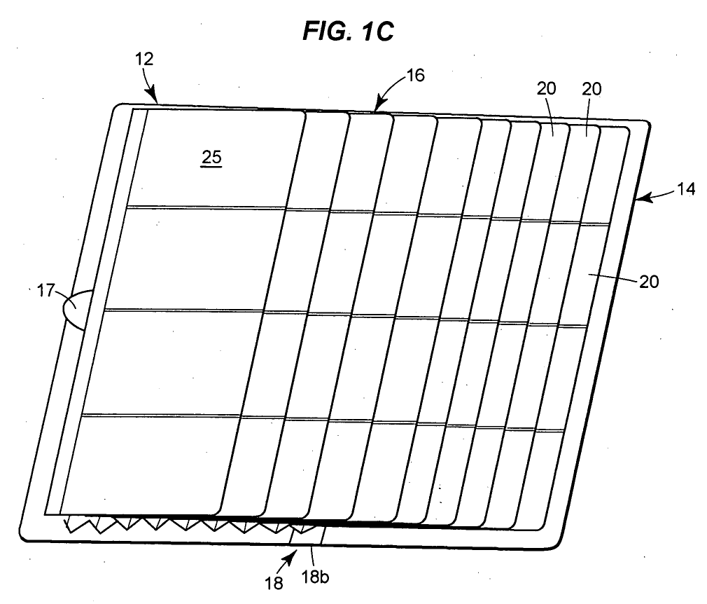

Generally, an organizer 10 is shown in FIGS. 1A-1C and includes a front panel 12 and a back panel 14 each having a top edge 11a and a bottom edge 11b, a pair of generally parallel side edges 12a, 12b, 14a, 14b and an inner surface 13a, 15a and an outer surface 13b, 15b. The front panel 12 and back panel 14 are spaced apart from one another and lie in different planes overlying one another when the organizer 10 is closed. When the organizer 10 is open, the front and back panels 12, 14 can lie in substantially the same plane.

A parallelepiped binder panel 18 is disposed between and connects the front panel 12 and the back panel 14 and similarly can lie in a substantially identical plane as the front panel 12 and the back panel 14 when the organizer 10 is in an open condition. The binder panel 18 is hingedly joined to adjacent side edges 12a, 14a of the front panel 12 and the back panel 14, respectively, along side edges 18a, 18b of the binder panel 18 forming hinged or foldable joints. The hinged or foldable joints allow the front panel 12 and back panel 14 to fold to a closed condition in which the front and back panels 12, 14 confront one another. The front and back panels 12, 14 can be generally parallel to one another with the binder panel 18 oriented generally perpendicular to both the front and back panels 12, 14. As seen in FIG. 1B, in a closed condition, the front panel 12 and the back panel 14 overlay and can be substantially parallel to, or at a slight converging angle relative to one another while the binder panel 18 is substantially perpendicular to both the front and back panels 12, 14. The binder panel 18 further includes a top edge 19a and a bottom edge 19b. The top and bottom edges 19a, 19b can align with the top and bottom edges 11a, 11b of the front and back panels 12, 14 when the organizer 10 is in an open condition and the front and back panels 12, 14 are oriented in substantially the same plane.

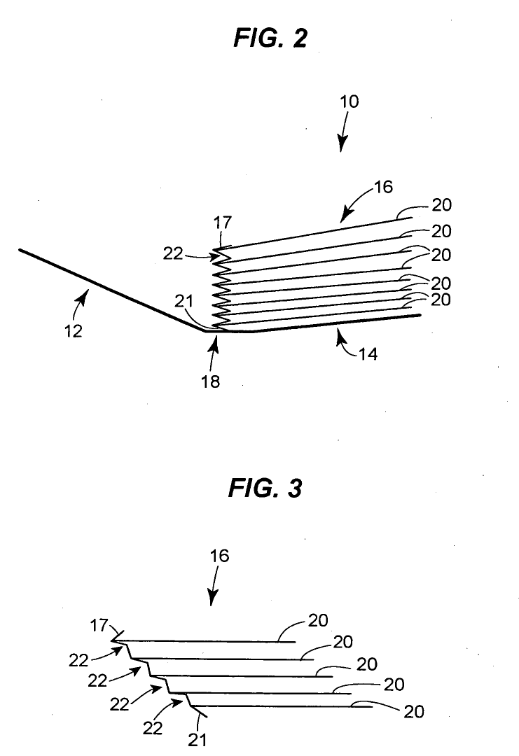

A storage insert 16 is attached to an inner surface of the binder panel 18. As seen in FIGS. 1C, 2 and 3, the storage insert 16 includes a plurality of sheets 20 joined together by an attachment structure 22. The attachment structures 22 in this example include two pleats 24, 26 hingedly joined together. Additionally, each of the sheets 20 includes at least one pocket 25 for storage of business cards, index cards, credit cards, sheets of paper or the like. The sheets 20 are made from a flexible plastic which may be transparent or semi-transparent and the pockets 25 may be made from a similar piece of material, parallelepiped in shape and attached to the sheets 20 at three sides creating an opening on one side for inserting the desired item. The storage insert 16 also includes a mounting flap 21 along one edge of the stack of sheets 20 and a tab 17 at the other end of the stack of sheets 20.

Referring again to FIG. 1A, the mounting flap 21 of the storage insert 16 is affixed to the binder panel 18 of the organizer 10. The mounting flap 21 may be affixed to the binder panel 18 by any suitable means, such as, for example, glued or sewn. By joining the storage insert 16 to the binder panel 18, the inner surfaces 13a, 15a of the front cover 12 and the back cover 14 are freed for additional storage features.

This feature is particularly advantageous in that a wide range of objects may be stored within the organizer 10 in addition to and apart from the storage insert 16. For example, additional pockets 23, or holders 27, of various sizes may be disposed on the inner surfaces 13a, 15a of the front panel 12 and the back panel 14 for storage of credit cards, cell phones, calculators, writing instruments and the like. A user may be able to store virtually anything he/she needs in these additional storage pockets 23 or holders 27.

In a closed condition, the storage insert 16 is sandwiched between the front panel 12 and the back panel 14 as seen in FIG. 1B. The binder portion 18 is sized such that the depth of the storage insert 16 in a closed condition is preferably slightly smaller than the width of the binder portion 18. This configuration of the binder portion 18 allows the front panel 12 and the back panel 14 to lie generally parallel to one another when the organizer 10 is in a closed condition, or even angled to taper or slightly converge closer to one another moving away from the binder panel 18.

FIG. 1C illustrates the organizer 10 in an open condition. A user can access and extend or expand the storage insert 16 with the front and back panels 12, 14 opened. In this configuration, a user can extend the storage insert 16 by pulling on the tab 17. A user can then view at least a part of and access each subsequent sheet 20 in the storage insert 16. In this condition, a user can rapidly locate items stored in any one of the plurality of sheets 20.

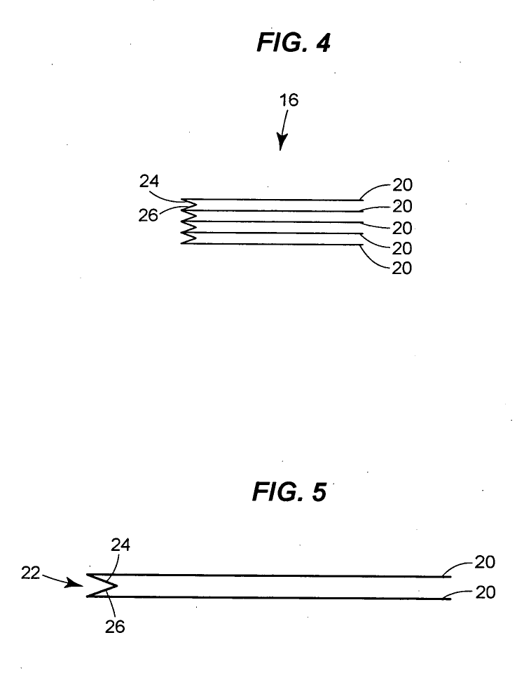

In a retracted condition, as shown in FIG. 4, the pleats 24, 26 fold back onto one another such that they are at a small acute angle to one another and lie substantially parallel and adjacent one another. In this condition, the sheets 20 of the storage insert 16 are stacked parallel and overlie one another in an efficient storage configuration. In the close up view of FIG. 5, the arrangement of the attachment structure 22 is evident. Each pleat 24, 26 is attached to a sheet 20 along one edge and can be integrally attached to the adjacent pleat 24, 26 along a second edge. The integral attachment between each pair of pleats 24, 26 and between each sheet 20 and its connected pleats 24, 26, can be a living hinge. While the embodiment of FIGS. 1-5 includes an attachment structure as outlined above, other attachment structure configurations are possible. For example, a single connection leaf could be employed instead of two pleats. One skilled in the art can select the shape and configuration of the attachment structure 22 according to particular requirements of individual designs.

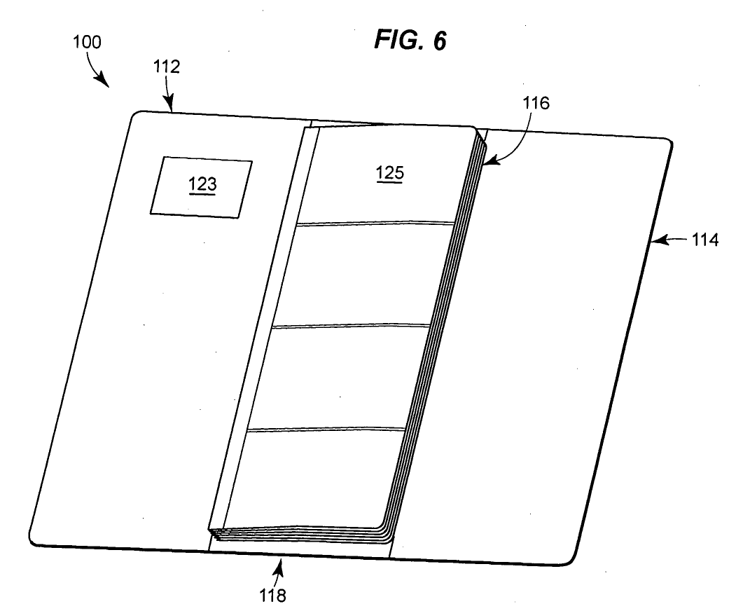

FIG. 6 illustrates an alternate embodiment of an organizer 100. In this embodiment, a binder panel 118 is significantly wider than the binder panel 18 of the embodiment of FIGS. 1-5. The binder panel 118 may be any size and/or shape which allows a front panel 112 and a back panel 114 to fold relative to the binder panel 118. Additionally, in the embodiment of FIG. 6, the front panel 112 and back panel 114 fold into planes essentially parallel to one another as in the embodiments of FIGS. 1-5. However, the storage insert 116 in this embodiment is disposed between the back panel 114 and the binder panel 118 when the organizer 110 is in a closed condition. All three of the panels 112, 114 and binder 118 fold to a generally parallel, tri-fold configuration in this example. The storage insert 116 is sized similar to the binder panel 118 but fits sandwiched between two panels within the tri-fold configuration.

Although certain features and functions have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An organizer comprising:
a first panel having a top edge, a bottom edge, and a pair of opposed side edges;
a second panel having a top edge, a bottom edge, and a pair of opposed side edges;
a binder panel having a top edge and a bottom edge and two opposed side edges, the binder panel positioned between adjacent edges of the first and second side panels and foldably joined to the adjacent edges, the first and second side panels and the binder panel arranged so that in an open configuration, the first panel, the second panel and the binder panel can lie in the same plane and so that in a closed configuration, the first panel and the second panel can fold to overlie one another; and
a storage insert having a plurality of sheets;
wherein the storage insert is affixed to the binder panel.

2. The organizer of claim 1, wherein the storage insert includes a mounting flap affixed to the binder panel.

3. The organizer of claim 1 further including a storage feature on an interior surface of at least one of the first panel and the second panel.

4. The organizer of claim 3, wherein the storage feature is a pocket.

5. The organizer of claim 3, wherein the storage feature is a hook and loop fastener.

6. The organizer of claim 3, wherein the storage feature is a holder.

7. The organizer of claim 1, wherein the storage insert includes a plurality of pockets on each of the sheets.

8. The organizer of claim 1, wherein each of the plurality of sheets is attached to at least one adjacent sheet with an attachment structure.

9. The organizer of claim 8, wherein the plurality of sheets is arranged to provide an extended configuration wherein a portion of each sheet in the plurality of sheets is exposed for viewing.

10. The organizer of claim 1, wherein the binder panel is wider than one of the first and second panels.

11. The organizer of claim 1, wherein the first and second panels and the binder panel are arranged such that the first and second panels are substantially parallel and adjacent to one another and the binder panel is substantially parallel to the first and second panels in a tri-fold configuration when the organizer is in the closed condition.

12. The organizer of claim 1, wherein the first and second panels and the binder panel are arranged such that the first and second panels generally overlie one another and the binder panel is generally perpendicular to both the first and second panels when the organizer is in the closed condition.

13. The organizer of claim 1, wherein the storage insert is attached to the binder panel with an adhesive.

14. The organizer of claim 1, wherein the storage insert is sewn to the binder panel.

15. An organizer comprising:
a first panel having a top edge, a bottom edge, and a pair of opposed side edges;
a second panel having a top edge, a bottom edge, and a pair of opposed side edges;
a binder panel having a top edge and a bottom edge, the binder panel positioned between adjacent edges of the first and second panels and foldably joined to said adjacent edges, the first and second panels and the binder panel arranged so that in an open configuration, the first side panel, the second side panel and the binder panel can lie in substantially the same plane and so that in a closed configuration, the first panel and the second panel can fold to overlie one another; and
a storage insert having a plurality of plastic sheets and a mounting flap, each of the sheets having at least one pocket formed thereon,
wherein the mounting flap of the storage insert is affixed to the binder panel, and
wherein both of the first and second panel interior surfaces include a storage feature.

16. The organizer of claim 15, wherein the first and second panels and the binder panel are arranged such that the first and second panels are substantially parallel and adjacent to one another and the binder panel is substantially parallel to the first and second panels in a tri-fold configuration when the organizer is in the closed condition.

17. The organizer of claim 15, wherein the first and second panels and the binder panel are arranged such that the first and second panels can fold to confront one another and the binder panel is generally perpendicular to both the first and second panels when the organizer is in the closed condition.

18. The organizer of claim 15, wherein the mounting flap is attached to the binder panel with an adhesive.

19. The organizer of claim 15, wherein the mounting flap is sewn to the binder panel.

20. The organizer of claim 15, wherein the storage feature is a writing utensil holder.
